(19) United States
(12) Patent Application Publication
(10) Pub. No.: US 2002/0106812 A1
(43) Pub. Date: Aug. 8, 2002

(54) Fluid drop dispensing

(76) Inventor: William D. Fisher, San Jose, CA (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/771,092

(22) Filed: Jan. 26, 2001

(51) Int. Cl. B01L 3/02

(52) U.S. Cl. 436/180; 422/100

(57) ABSTRACT

A method and apparatus in which a pulse jet (such as a thermoelectric or piezoelectric pulse jet) deposit drops and the pulse jet is struck at least once. A housing of the pulse jet may particularly be struck in a same direction in which drops are ejected from the pulse jet and, for example, a rate of 0.2 to 10 strikes/second with each strike delivering between 10 mJ to 150 mJ. The method and apparatus may particularly be applied application to the fabrication of biopolymer (such as DNA) arrays, and in the striking may for example particularly be applied after loading of the pulse jet through a drop dispensing orifice.

### FIELD OF THE INVENTION

This invention relates to dispensing drops from a pulse jet such as that used in fabricating arrays, particularly biopolymer arrays (such polynucleotide arrays, and particularly DNA arrays) which are useful in diagnostic, screening, gene expression analysis, and other applications.

### BACKGROUND OF THE INVENTION

In many applications, it is desired to dispense drops from a fluid dispensing head having one or more dispensers onto a substrate to fabricate a desired article. Such a technique may be used in the fabrication of biopolymer arrays. Biopolymer arrays, such as arrays of peptides or polynucleotides (such as DNA or RNA), are known and are used, for example, as diagnostic or screening tools. Such arrays include regions (sometimes referenced as features or spots) of usually different sequence biopolymers arranged in a predetermined configuration on a substrate. The arrays, when exposed to a sample, will exhibit a pattern of binding which is indicative of the presence and/or concentration of one or more components of the sample, such as an antigen in the case of a peptide array or a polynucleotide of particular sequence in the case of a polynucleotide array. The binding pattern can be detected by reading the array, for example, by observing a fluorescence pattern on the array following exposure to a fluid sample in which all potential targets (for example, DNA) in the sample have been labeled with a suitable fluorescent label.

Methods of fabricating biopolymer arrays by depositing multiple drops at the sites at which biopolymers are to be provided, include in situ synthesis methods or deposition of the previously obtained biopolymers. The in situ synthesis methods include those described in U.S. Pat. No. 5,449,754 for synthesizing peptide arrays, as well as WO 98/41531 and the references cited therein for synthesizing polynucleotides (specifically, DNA). Such in situ synthesis methods can be basically regarded as iterating the sequence of depositing drops of: (a) a protected monomer onto predetermined locations on a substrate to link with either a suitably activated substrate surface (or with a previously deposited deprotected monomer); (b) deprotecting the deposited monomer so that it can now react with a subsequently deposited protected monomer; and (c) depositing another protected monomer for linking. Different monomers may be deposited at different regions on the substrate during any one iteration so that the different regions of the completed array will have different desired biopolymer sequences. One or more intermediate further steps may be required in each iteration, such as oxidation and washing steps.

The “deposition method” basically involves depositing previously obtained biopolymers at predetermined locations on a substrate which are suitably activated such that the biopolymers can link thereto. The deposited biopolymers may, for example, be obtained from synthetic or biological sources. Biopolymers of different sequence may be deposited at different regions of the substrate to yield the completed array. Washing or other additional steps may also be used. Typical procedures known in the art for deposition of polynucleotides, particularly DNA such as whole oligomers or cDNA, are to load a small volume of DNA in solution in one or more drop dispensers such as the pulse jets in an inkjet head and fired the drops onto the substrate. Such a technique has been described, for example, in PCT publications WO 95/25116 and WO 98/41531, and elsewhere. This method has the advantage of non-contact deposition.

The present invention realizes as follows. Once a dispensing head is loaded with fluid, it typically needs to be primed for proper operation. However, after loading or priming the firing of a loaded pulse jet may still be unreliable (for example, no drop is dispensed when it should be, or a drop of incorrect or reduced size is dispensed). Without limiting the present invention, this is believed to be caused (at least in part) from a bubble (such as an air bubble) being created during the loading or priming and becoming trapped in a position which inhibits fluid dispensing (such as at or above a firing chamber of a pulse jet). Regardless of the cause, this may be particularly true where the fluid is loaded into the dispensing head through the same orifices from which it is later dispensed. When this happens, fluid in the dispensing head is unable to be dispensed or is dispensed improperly from the dispensing orifices making the head completely or partially inoperable or operating unreliably. This can result in the fabricated article having incompletely deposited regions. Methods of removing bubbles in other contexts have been suggested. For example, such as when a doctor taps a side of a loaded syringe to loosen any air bubbles. A previously known approach for removing trapped bubbles to increase firing reliability in a dispensing head is to force sufficient fluid through the head and out the dispensing orifices until it is believed that bubbles have been pushed out, and then to wipe any excess fluid from an external face of the head on which the orifice is positioned. However, in the situation where the fluid to be dispensed from a head is in limited supply or expensive, an undesirable amount of fluid may be lost with this approach. Furthermore, wiping excess fluid across an external face with multiple dispensing orifices for different fluids, may cause substantial cross-contamination problems between different orifices of a same head. These problems are particularly true of biopolymer array fabrication by the deposition method, where incompletely deposited regions may result in expensive arrays which produce incorrect results, where the quantities of different biopolymers such as DNA are usually very small and expensive, and where it is generally desired to minimize cross-contamination.

The present invention realizes that it would be desirable then, to provide a means by which firing reliability may be enhanced without unduly wasting fluid to be dispensed and not unduly causing cross-contamination of dispensing orifices.

### SUMMARY OF THE INVENTION

The present invention then, provides in one aspect a method comprising dispensing drops from a pulse jet and striking the pulse jet at least once. This includes the possibility of striking the pulse jet multiple times and repeating the procedure again one or more times (referred to as striking the pulse jet intermittently multiple times). In one embodiment the pulse jet includes a housing which encloses the chamber, and which housing has a discharge opening for drops. In this case, the housing is struck on a surface (such as an outside surface) with the member. Preferably, the housing is struck in a same direction in which drops are ejected from the pulse jet (that is, with some parallel vector components). Varying strike rates can be used, although typically the chamber is struck at a rate of 0.2 to 10 strikes/second or 1 to 5 strikes/second. Similarly, strikes of varying force may be used but typically each strike will deliver between 10 mJ to 150 mJ, or between 50 mJ to 100 mJ. Pulse jets of various construction may be used, although preferably the pulse jet will include either a thermoelectric or piezoelectric ejector in the chamber. While the striking of the pulse jet is believed to dislodge bubbles to improve pulse jet firing reliability, the present invention is not limited to such a requirement.

Any method of the present invention may be used as part of a method for fabricating an array of chemical moieties on a substrate. In the method, drops are dispensed from the pulse jet onto the substrate so as to form the array; and the pulse jet struck in any of the manners described herein. The chemical moieties may, for example, be biopolymers such as polynucleotides (for example, DNA) of different sequences.

The present invention further provides a drop deposition apparatus which includes a pulse jet having a chamber and an orifice through which drops are dispensed. A striker includes a strike member and an actuator to drive the strike member to strike the pulse jet at least once in any of the manners described herein. The pulse jet may, for example, be of any of the constructions described herein while the actuator may, for example, be constructed to strike the pulse jet in any of the manners described herein.

In another aspect, the present invention further provides an array fabrication apparatus. Such a fabrication apparatus includes a pulse jet and striker of any construction described herein. The apparatus may further include a pressure source which can apply a negative pressure to the chamber such that any fluid adjacent the orifice is drawn into the chamber. A positioning system moves the pulse jet between a dispensing station and a loading station. A controller controls the pulse jet, positioning system, pressure source, and striker actuator. In particular, the controller: moves the pulse jet between the loading and dispensing stations; applies the negative pressure to the chamber when the pulse jet is at the loading station with the orifice adjacent a fluid to be loaded so as to load the fluid into the chamber; dispenses drops from the pulse jet when at the dispensing station, so as to form the array; and controls the actuator so that the striker strikes the pulse jet at least once between the dispensing of drops by the pulse jet or in any of the manners described herein.

One or more of the various aspects of the present invention may provide one or more of the following, or other, useful benefits. For example, the dispensing of fluid in an effort to reduce improper firing of the pulse jet, may be reduced or avoided, while cross-contamination between dispensing orifices is not seriously promoted.

### BRIEF DESCRIPTION OF THE DRAWINGS

Embodiments of the invention will now be described with reference to the drawings in which:

FIGS. 1 and 2 schematically illustrate trapping of bubbles in a pulse jet;

FIG. 3 illustrates an apparatus of the present invention;

FIG. 4 illustrates a substrate carrying multiple arrays, such as may be fabricated by methods of the present invention;

FIG. 5 is an enlarged view of a portion of FIG. 4 showing multiple ideal spots or features;

FIG. 6 is an enlarged illustration of a portion of the substrate in FIG. 5; and

FIG. 7 is a schematic diagram of an apparatus of the present invention in the form of a central fabrication station;

To facilitate understanding, identical reference numerals have been used, where practical, to designate identical elements that are common to the figures.

### DETAILED DESCRIPTION OF THE INVENTION

In the present application, unless a contrary intention appears, the following terms refer to the indicated characteristics. A “biopolymer” is a polymer of one or more types of repeating units. Biopolymers are typically found in biological systems and particularly include polysaccharides (such as carbohydrates), and peptides (which term is used herein to include polypeptides and proteins) and polynucleotides as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

An “array”, unless a contrary intention appears, includes any one, two or three dimensional arrangement of addressable regions bearing a particular chemical moiety or moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one which is to be evaluated by the other (thus, either one could be an unknown mixture of polynucleotides to be evaluated by binding with the other). An “array layout” refers collectively to one or more characteristics of the features, such as feature positioning, one or more feature dimensions, errors, or some indication of a moiety at a given location. “Hybridizing” and “binding”, with respect to polynucleotides, are used interchangeably.

When one item is indicated as being “remote” from another, this is referenced that the two items are at least in different buildings, and may be at least one mile, ten miles, or at least one hundred miles apart. “Communicating” information references transmitting the data representing that information as electric or electromagnetic (including light) signals over a suitable communication channel (for example, a private or public network). It will also be appreciated that throughout the present application, that words such as “top”, “upper”, and “lower” are used in a relative sense only. “Fluid” is used herein to reference a liquid. A “set” or a “sub-set” may have one or more members (for example, one or more drops). A “processor” includes any one or more electrical and/or optical processors which can execute all the steps required of it, or any hardware or software combination which will perform those or equivalent steps, such as one or more general purpose digital microprocessors suitably programmed from a computer readable medium carrying necessary program code. Any “memory” includes any suitable device or combination of devices in which a processor can store and/or retrieve data as required, such as magnetic, optical, or solid state storage devices (including magnetic or optical disks or tape or RAM, or any other suitable device or combination of them, either fixed or portable). Steps recited in a particular order in relation to any method may be executed in the order described or can be changed to any logically possible order. Reference to a singular item, includes the possibility that there are plural of the same items present. All patents and other cited references are incorporated into this application by reference.

In the below description, the theory on which the present invention is thought to operate by removing bubbles and thereby enhancing pulse jet firing reliability, is described although the present invention is not necessarily limited to a requirement of removing bubbles.

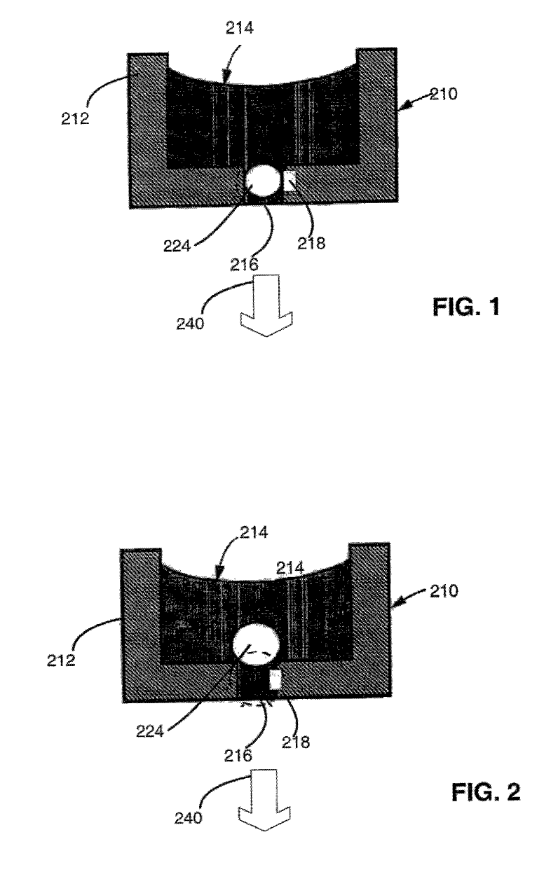

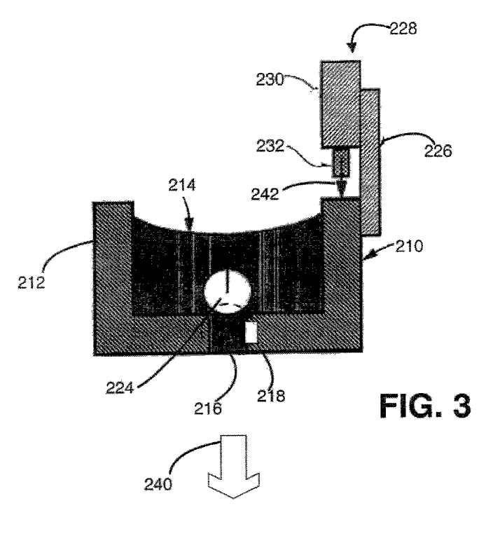

Referring first to FIGS. 1 and 2, there is schematically illustrated a single pulse jet of a drop deposition head 210. Each pulse jet includes a rigid housing 212 which includes a reservoir chamber 214 and an orifice 216 through which drops are ejected in a direction of arrow 240. A thermoelectric or piezoelectric ejector 218 is positioned in chamber 214 such that when an electric pulse is provided thereto, a drop of fluid in chamber 214 is ejected through orifice 216. It will be understood though, as discussed below, that head 210 will typically contain multiple such pulse jets each with an orifice 216 extending through a common integral plate. In practice, a bubble 224 may become lodged in the firing region of the pulse jet (as illustrated in FIG. 1) or on top of such region (as illustrated in FIG. 2) following loading with a fluid, during multiple firings of ejector 218 to prime the pulse jet, or at some other time, leading to unreliability in the firing of the pulse jet. It is believed, without limiting the scope of the present invention, that these can be dislodged using an apparatus of the present invention such as illustrated in FIG. 3. Such an apparatus includes, in addition to the head 210, a striker 228. Striker 228 has a strike member 232 and an actuator 230 to drive the strike member to strike an outside surface of housing 212 of the pulse jet in a direction of arrow 242. Actuator 230 may, for example, be pneumatic or electric and when activated pushes strike member 232 rapidly to strike the outside of housing 212 and immediately withdraws it back out of contact with housing 212 so as not to dampen or prevent resulting vibrations of housing 212 or other components of the pulse jet head (or at least withdrawn sufficiently fast so as not to reduce dampening by more than 50%, 20% or 10%). Actuator 230 and strike member 232 are constructed to be able to accomplish such striking at multiple times, each at a time spaced from the other (that is, intermittently multiple times). Note that the direction of striking is parallel to that of the direction of drop ejection. The head could be struck in the same direction as the direction of drop ejection (that is, the angle between them is less than 90 degrees). However, it is also possible to strike the head in other directions.

The manner in which the striking of the housing 212 is thought to operate, is believed to be as follows (again, without limiting the scope of the present invention). In particular, when housing 212 is struck in the manner described, it is mechanically displaced slightly from its resting position by the delivered impulse force. Since the striker is quickly withdrawn the housing 212 and fluid or trapped bubbles within it, should tend to move back to their resting position and vibrate at their own natural frequency of vibration in the process of doing so. The goal is to dislodge a trapped bubble from the firing chamber as a result of the applied impulse force releasing the bubble from the contact surface holding it and allows it to float to the surface of the fluid reservoir such that efficient dispensing of the fluid from head 210 is possible. It is believed that an impulse force provides an advantage over a vibrator placed into contact with head 210 in that the impulse force provides a large spectrum of excitation frequencies to the head as opposed to just one. Also, the only tuning required of an impulse force is the magnitude of the applied force from the striker. Since a vibrator only delivers a single frequency at any given time, use of a vibrator would likely require determining an appropriate frequency to use. Further, the shock induced by an impulse force on the trapped bubble in the dispensing head has the additional feature that when the bubble contact points with a surface are disturbed, the fluid momentum that is also created by the impulse force helps to push fluid between the bubble and its contact points to release it. The effectiveness of the impulse force is also determined by the direction it is applied to head 210 as discussed above.

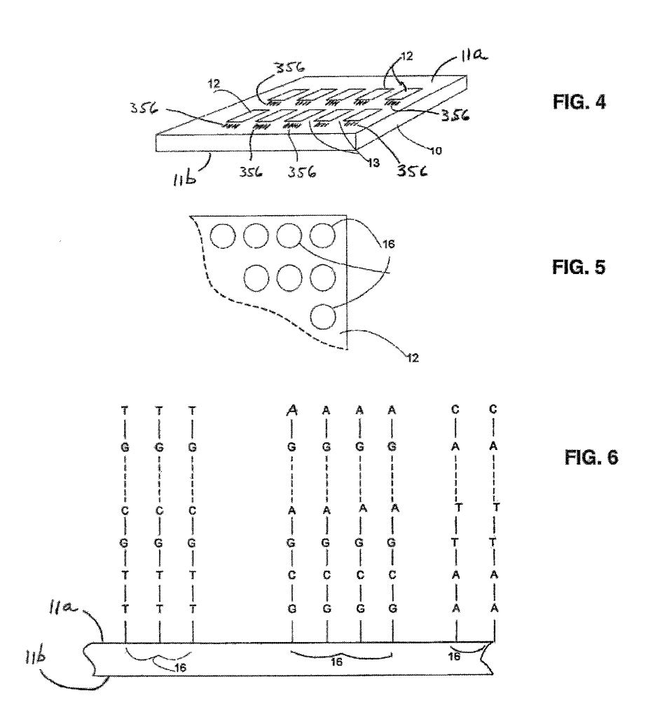

Referring now to FIGS. 4-6, arrays which may be fabricated using apparatus and methods of the present invention are shown. In particular, a contiguous planar substrate 10 carries one or more such arrays 12 disposed across a front surface 11a of substrate 10 and separated by inter-array areas 13. A back surface 11b of substrate 10 does not carry any arrays 12. The arrays on substrate 10 can be designed for testing against any type of sample, whether a trial sample, reference sample, a combination of them, or a known mixture of polynucleotides (in which latter case the arrays may be composed of features carrying unknown sequences to be evaluated). Each array 12 may have associated with it a unique identifier in the form of a bar code 356 described below. By “unique” in this sense does not mean the identifier is absolutely unique, but it is sufficiently long so as unlikely to be confused with another identifier on another array (and is preferably unique as to a particular central fabrication station on a given communication channel). While ten arrays 12 are shown in FIG. 4 and the different embodiments described below may use a substrate with only one array 12 on it, it will be understood that substrate 10 and the embodiments to be used with it may have any number of desired arrays 12. Similarly, substrate 10 may be of any shape, and any apparatus used with it adapted accordingly. Depending upon intended use, any or all of arrays 12 may be the same or different from one another and each will contain multiple spots or features 16 of biopolymers such as polynucleotides. A typical array may contain from more than ten, more than one hundred, more than one thousand or ten thousand features, or even more than from one hundred thousand features. All of the features 16 may be different, or some or all could be the same. In the embodiment illustrated, there are interfeature areas 17 between features, which do not carry any polynucleotide. It will be appreciated though, that the interfeature areas 17 could be of various sizes and configurations. It will be appreciated that there need not be any space separating arrays 12 from one another, nor features 16 within an array from one another. However, in the case where arrays 12 are formed by the deposition method as described above, such inter-array and inter-feature areas 17 will typically be present. Each feature carries a predetermined polynucleotide (which includes the possibility of mixtures of polynucleotides). As per usual, A, C, G, T represent the usual nucleotides. It will be understood that there may be a linker molecule (not shown) of any known types between the front surface 11a and the first nucleotide.

FIGS. 5 and 6 are enlarged views illustrating portions of ideal features where the actual features formed are the same as the desired features (sometimes referenced as the “target” or “aim” features), with each feature 16 being uniform in shape, size and composition, and the features being regularly spaced. In practice, such an ideal result is difficult to obtain.

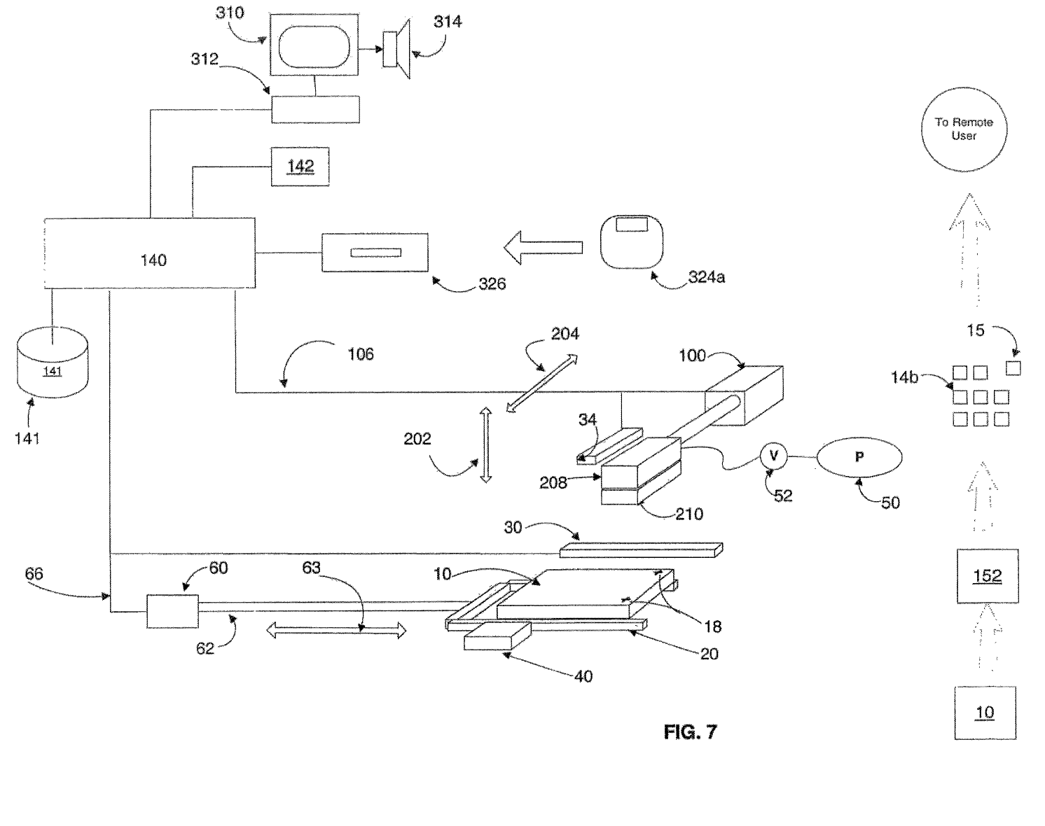

Referring now to FIG. 7, an apparatus of the present invention which can be used to fabricate arrays according to the present invention, will now be described. The apparatus of FIG. 7 includes a substrate station 20 (sometimes referenced as a “dispensing station”) on which can be mounted a substrate 10. Pins or similar means (not shown) can be provided on substrate station 20 by which to approximately align substrate 10 to a nominal position thereon. Substrate station 20 can include a vacuum chuck connected to a suitable vacuum source (not shown) to retain a substrate 10 without exerting too much pressure thereon, since substrate 14 is often made of glass.

Dispensing head 210 is retained by a head retainer 208. The positioning system includes a carriage 62 connected to a first transporter 60 controlled by processor 140 through line 66, and a second transporter 100 controlled by processor 140 through line 106. Transporter 60 and carriage 62 are used execute one axis positioning of station 20 (and hence mounted substrate 10) facing the dispensing head 210, by moving it in the direction of arrow 63, while transporter 100 is used to provide adjustment of the position of head retainer 208 (and hence head 210) in a direction of axis 204. In this manner, head 210 can be scanned line by line, by scanning along a line over substrate 10 in the direction of axis 204 using transporter 100, while line by line movement of substrate 10 in a direction of axis 63 is provided by transporter 60. In the case where arrays 12 are to be fabricated by the deposition method, transporter 60 can also move a load station 40 beneath head 210 such that polynucleotides or other biopolymers obtained from different vessels from a customer, can be loaded into head 210. A pressure source which includes a source of negative and positive pressure 50 is controlled through a valve 52 (in turn under the control of processor 140) to deliver either negative or positive pressure to head 210. A load station 40 and method of use is described in detail in U.S. patent application Ser. No. 09/183,604 for “Method And Apparatus For Liquid Transfer” filed Oct. 30, 1998 by Tella et al, incorporated herein by reference. Suitable negative pressure values are described in U.S. patent application Ser. No. 09/302,922 for “Fabricating Biopolymer Arrays” filed Apr. 30, 1999 by Webb et al. In the case where arrays 12 are to be fabricated by the in situ method, supplies of suitable reagents can be provided in fluid communication with head 210, and a flood station can be provided for steps in the process in which all features to be formed are exposed to the same solution. Such features are described in more detail in U.S. patent application Ser. No. 09/356249 for “Biopolymer Arrays And Their Fabrication” filed by Perbost on Jul. 16, 1999, incorporated herein by reference. Head 210 may also optionally be moved in a vertical direction 202, by another suitable transporter (not shown).

It will be appreciated that other scanning configurations could be used. It will also be appreciated that both transporters 60 and 100, or either one of them, with suitable construction, could be used to perform the foregoing scanning of head 210 with respect to substrate 10. Thus, when the present application recites “positioning” one element (such as head 210) in relation to another element (such as one of the stations 20 or substrate 10) it will be understood that any required moving can be accomplished by moving either element or a combination of both of them. The head 210, the positioning system, and processor 140 together act as the deposition system of the apparatus. An encoder 30 communicates with processor 140 to provide data on the exact location of substrate station 20 (and hence substrate 10 if positioned correctly on substrate station 20), while encoder 34 provides data on the exact location of holder 208 (and hence head 210 if positioned correctly on holder 208). Any suitable encoder, such as an optical encoder, may be used which provides data on linear position.

Head 210 may have multiple pulse jets, such as piezoelectric or thermoelectric type pulse jets as may be commonly used in an ink jet type of printer and may, for example, include multiple chambers 214 each communicating with a corresponding set of multiple drop dispensing orifices and multiple ejectors which are positioned in the chambers opposite respective orifices 216. Each ejector is in the form of an electrical resistor operating as a heating element under control of processor 140 (although piezoelectric elements could be used instead). Each orifice 216 with its associated ejector and portion of the chamber 214, defines a corresponding pulse jet. It will be appreciated that head 210 could, for example, have more or less pulse jets as desired (for example, at least ten or at least one hundred pulse jets). Application of a single electric pulse to an ejector will cause a droplet to be dispensed from a corresponding orifice. Certain elements of the head 210 can be adapted from parts of a commercially available thermal inkjet print head device available from Hewlett-Packard Co. as part no. HP51645A. A suitable head construction is described in U.S. patent application Ser. No. 09/150,507 filed Sept. 9, 1998 by Caren et al. for “Method And Multiple Reservoir Apparatus For Fabrication Of Biomolecular Arrays”, incorporated herein by reference. Alternatively, multiple heads could be used instead of a single head 210, each being similar in construction to head 210 and being movable in unison by the same transporter or being provided with respective transporters under control of processor 140 for independent movement.

As is well known in the ink jet print art, the amount of fluid that is expelled in a single activation event of a pulse jet, can be controlled by changing one or more of a number of parameters, including the orifice diameter, the orifice length (thickness of the orifice member at the orifice), the size of the deposition chamber, and the size of the heating element, among others. The amount of fluid that is expelled during a single activation event is generally in the range about 0.1 to 1000 pL, usually about 0.5 to 500 pL and more usually about 1.0 to 250 pL. A typical velocity at which the fluid is expelled from the chamber is more than about 1 m/s, usually more than about 10 m/s, and may be as great as about 20 m/s or greater. As will be appreciated, if the orifice is in motion with respect to the receiving surface at the time an ejector is activated, the actual site of deposition of the material will not be the location that is at the moment of activation in a line-of-sight relation to the orifice, but will be a location that is predictable for the given distances and velocities.

The apparatus can deposit drops to provide features which may have widths (that is, diameter, for a round spot) in the range from a minimum of about 10 μm to a maximum of about 1.0 cm. In embodiments where very small spot sizes or feature sizes are desired, material can be deposited according to the invention in small spots whose width is in the range about 1.0 μm to 1.0 mm, usually about 5.0 μm to 500 μm, and more usually about 10 μm to 200 μm.

The apparatus further includes a display 310, speaker 314, and operator input device 312. Operator input device 312 may, for example, be a keyboard, mouse, or the like. Processor 140 has access to a memory 141, and controls print head 210 (specifically, the activation of the ejectors therein), operation of the positioning system, operation of each jet in print head 210, operation of actuator 230 of striker 228, and operation of display 310 and speaker 314. Memory 141 may be any suitable device or devices in which processor 140 can store and retrieve data, such as magnetic, optical, or solid state storage devices (including magnetic or optical disks or tape or RAM, or any other suitable device, either fixed or portable). Processor 140 may include a general purpose digital microprocessor suitably programmed from a computer readable medium carrying necessary program code, to execute all of the steps required for by the present invention for array production, or any hardware or software combination which will perform those or equivalent steps. The programming can be provided remotely to processor 140, or previously saved in a computer program product such as memory 141 or some other portable or fixed computer readable storage medium using any of those devices mentioned below in connection with memory 141. For example, a magnetic or optical disk 324a may carry the programming, and can be read by disk writer/reader 326.

A writing system which is under the control of processor 140, includes a writer in the form of a printer 150 which applies identifiers onto substrate 10 by printing them in the form of the bar codes 356 directly onto substrate 10 (or indirectly such as onto a label later attached to the substrate), each in association with a corresponding array 12 as illustrated in FIG. 4. Alternatively, the identifiers can by applied onto a housing carrying the substrate or label to be applied to such substrate or housing. Printer 150 may accomplish this task before or after formation of the array by the drop deposition system. A cutter 152 is provided to cut substrate 10 into individual array units 15 each carrying a corresponding array 12 and bar code 356.

The operation of the fabrication station by the deposition method will now be described with reference to FIG. 7 in particular. It will be assumed that a substrate 10 on which arrays 12 are to be fabricated, is in position on station 20 and that processor 140 is programmed with the necessary layout information to fabricate target arrays 12. Processor 140 controls fabrication of each array by first operating the positioning system to move the head to a load station 40 with orifices 216 opposite and facing respective drops or reservoirs of different sequence biopolymers. Valve 52 is then operated by processor 140 so that pressure source 50 provides a negative pressure to head 210 and hence each chamber 214 such that fluid adjacent each orifice 216 is drawn therethrough and into chamber 214 to load head 210. After the pulse jets are loaded, processor may optionally prime each by firing multiple times while head 210 is positioned over some location which will not become part of a fabricated array, either for a predetermined number of firings or until a drop is actually ejected. The outside surface of the pulse jet housing 212 is then struck multiple times by strike member 232 by processor 140 energizing actuator 230 as required. For example, the outside of the chamber housing 212 may be struck at a rate of 0.2 to 10 strikes/second (or 1 to 5 strikes/second) with sufficient force to deliver between 10 mJ to 150 mJ (or 50 mJ to 100 mJ). Processor 140 then operates the positioning system as described above to coordinate movement of substrate 10 with the depositing of one or more drops of each biopolymer from orifices of head 210 onto a corresponding region (feature) on the substrate 10. Head 210 is moved to the loading station and reloaded with the same or different set of multiple different biopolymers of different sequence, and the deposition repeated, as required to form the arrays 12. The striking multiple times may optionally be repeated intermittently at various times between the dispensing of drops by head 210 (for example, after every reloading of head 210, or even before reloading). Note that in this situation no drops or fluid are being dispensed by the head while striking is occurring. Further, since head 210 is typically quite small, the housing is struck by the strike member 232 at a position on the outside of housing 212 which is typically no more than about 10 cm or less (for example, no more than 5 cm or no more than 2 cm) from at least one or all of the orifices 216 on head 210.

The end result of the above procedure is a multiple fabricated arrays 12 on substrate 10 as shown in FIGS. 4-6. In the case of the in situ method, the procedure is essentially the same except head 210 is typically provided with a constant supply of biomonomers and other reagents for drop deposition, through a port serving one or more pulse jets, so that reloading is not required. Additionally, in the case of the in situ method processor 140 will send the array to the flood station as needed. During or following array fabrication, arrays may be inspected for quality control (“QC”), for example for information on missing features, misplaced features, features of incorrect dimensions, or other physical characteristics, in a manner as described in U.S. patent application Ser. No. 09/302898 for “Polynucleotide Array Fabrication” filed Apr. 30, 1999 by Caren et al., and allowed U.S. application Ser. No. 09/419447 for “Biopolymer Array Inspection” filed Oct. 15, 1999 by Fisher, both incorporated herein by reference. The substrate 10 is then sent to a cutter 152 wherein portions of substrate 10 carrying an individual array 12 and its associated local identifier 356 are separated from the remainder of substrate 10, to provide multiple array units 15. The array unit 15 is optionally placed in a package for shipping to a remote user station.

At the user station, the unit 15 is received from the remote fabrication station. A sample, for example a test sample, is exposed to the array 12 on the array unit 15. Following hybridization and washing in a known manner, the array unit 15 is then inserted a scanner for reading of the array (such as information representing the fluorescence pattern on the array 12) to obtain read results. For example, such a scanner may be similar to the GENEARRAY scanner available from Hewlett-Packard, Palo Alto, Calif. The data obtained from reading may be processed to obtain processed results, such as obtained by rejecting a reading for a feature which is below a predetermined threshold and/or forming conclusions based on the pattern read from the array (such as whether or not a particular target sequence may have been present in the sample). The results of the reading (processed or not) can be forwarded (such as by communication over a communication channel such as a Wide Area Network, telephone network, satellite network, or any other suitable communication channel) to be received at a remote location for further evaluation and/or processing, or use. This data may be transmitted by others as required to reach any other location (remote or local), or re-transmitted to elsewhere as desired. Methods and apparatus for reading of arrays are described in more detail in allowed U.S. patent application Ser. No. 09/359536 for “Chemical Array Fabrication With Identifier” by Cattell.

In a variation of the above, it is possible that each array 12 and its substrate 10 may be contained with a suitable housing. Such a housing may include a closed chamber accessible through one or more ports normally closed by septa, which carries the substrate 10. In this case, the identifier for each array may be applied to the housing.

Modifications in the particular embodiments described above are, of course, possible. For example, where a pattern of arrays is desired, any of a variety of geometries may be constructed other than the organized rows and columns of arrays 12 of FIG. 4. For example, arrays 12 can be arranged in a series of curvilinear rows across the substrate surface (for example, a series of concentric circles or semi-circles of spots), and the like. Similarly, the pattern of regions 16 may be varied from the organized rows and columns of spots in FIG. 5 to include, for example, a series of curvilinear rows across the substrate surface(for example, a series of concentric circles or semi-circles of spots), and the like. Even irregular arrangements of the arrays or the regions within them can be used provided the locations of features of identified biopolymers are known.

The present methods and apparatus may be used to deposit biopolymers or other moieties on surfaces of any of a variety of different substrates, including both flexible and rigid substrates. Thus, in any of the above described methods “biopolymer” or “biopolymers” could more broadly be replaced with “moiety” or “moieties”. Preferred materials for the substrate provide physical support for the deposited material and endure the conditions of the deposition process and of any subsequent treatment or handling or processing that may be encountered in the use of the particular array. The array substrate may take any of a variety of configurations ranging from simple to complex. Thus, the substrate could have generally planar form, as for example a slide or plate configuration, such as a rectangular or square or disc. In many embodiments, the substrate will be shaped generally as a rectangular solid, having a length in the range about 4 mm to 200 mm, usually about 4 mm to 150 mm, more usually about 4 mm to 125 mm; a width in the range about 4 mm to 200 mm, usually about 4 mm to 120 mm and more usually about 4 mm to 80 mm; and a thickness in the range about 0.01 mm to 5.0 mm, usually from about 0.1 mm to 2 mm and more usually from about 0.2 to 1 mm. However, larger substrates can be used, particularly when such are cut after fabrication into smaller size substrates carrying a smaller total number of arrays 12. Substrates of other configurations and equivalent areas can be chosen. The configuration of the array may be selected according to manufacturing, handling, and use considerations.

The substrates may be fabricated from any of a variety of materials. In certain embodiments, such as for example where production of binding pair arrays for use in research and related applications is desired, the materials from which the substrate may be fabricated should ideally exhibit a low level of non-specific binding during hybridization events. In many situations, it will also be preferable to employ a material that is transparent to visible and/or UV light. For flexible substrates, materials of interest include: nylon, both modified and unmodified, nitrocellulose, polypropylene, and the like, where a nylon membrane, as well as derivatives thereof, may be particularly useful in this embodiment. For rigid substrates, specific materials of interest include: glass; fused silica, silicon, plastics (for example, polytetrafluoroethylene, polypropylene, polystyrene, polycarbonate, and blends thereof, and the like); metals (for example, gold, platinum, and the like).

The substrate surface onto which the polynucleotide compositions or other moieties is deposited may be porous or non-porous, smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated),

Various further modifications to the particular embodiments described above are, of course, possible. Accordingly, the present invention is not limited to the particular embodiments described in detail above.

What is claimed is:

1. A method comprising dispensing drops from a pulse jet and striking the pulse jet at least once.

2. A method according to claim 1 wherein the pulse jet is struck intermittently multiple times.

3. The method of claim 2 wherein the pulse jet includes a housing enclosing a chamber and having a discharge opening for drops, and wherein the housing is struck on an outside surface with a member.

4. The method according to claim 3 wherein the housing is struck in a same direction in which drops are ejected from the pulse jet.

5. The method of claim 3 wherein the chamber is struck at a rate of 0.2 to 10 strikes/second.

6. The method of claim 3 wherein the chamber is struck at a rate of 1 to 5 strikes/second.

7. The method according to claim 3 wherein each strike delivers between 10 ml to 150 mJ.

8. The method according to claim 3 wherein each strike delivers between 50 mJ to 100 ml.

9. The method according to claim 2 wherein the pulse jet includes a thermoelectric ejector in the chamber.

10. The method according to claim 2 wherein the pulse jet includes a piezoelectric ejector in the chamber.

11. A method of fabricating an array of chemical moieties on a substrate, comprising:
dispensing drops from a pulse jet onto the substrate so as to form the array; and
intermittently striking the pulse jet multiple times.

12. A method according to claim 11 wherein multiple strikes are applied between the dispensing of drops by the pulse jet.

13. A method according to claim 11 wherein the chemical moieties are polynucleotides of different sequences.

14. A method according to claim 13 wherein the polynucleotides are DNA.

15. A drop deposition apparatus comprising:
a pulse jet having a chamber and an orifice through which drops are dispensed;
a striker including a strike member and actuator to drive the strike member to strike the pulse jet at least once.

16. A drop deposition apparatus according to claim 15 wherein the actuator drives the strike member to intermittently strike the pulse jet multiple times.

17. An apparatus according to claim 16 wherein the pulse jet includes a housing enclosing a chamber and having a discharge opening for drops, and wherein the housing is struck on an outside surface with the strike member.

18. An apparatus according to claim 17 wherein the housing is struck in a same direction in which drops are ejected from the pulse jet.

19. An apparatus according to claim 16, additionally comprising a controller which controls the actuator so that the pulse jet is struck at a rate of 0.2 to 10 strikes/second.

20. An apparatus according to claim 19 wherein the controller controls the actuator so that the pulse jet is struck at a rate of 1 to 5 strikes/second.

21. An apparatus according to claim 16 additionally comprising a controller which controls the actuator so that each strike delivers between 10 mJ to 150 mJ.

22. An apparatus according to claim 21 wherein each strike delivers between 50 mJ to 100 mJ.

23. An apparatus according to claim 16 wherein the pulse jet includes a thermoelectric ejector in the chamber.

24. An apparatus according to claim 16 wherein the pulse jet includes a piezoelectric ejector in the chamber.

25. An array fabrication apparatus comprising:
(a) a pulse jet having a chamber and an orifice through which drops are dispensed;
(b) a striker including a strike member and actuator to drive the strike member to strike the pulse at least once;
(c) a pressure source which can apply a negative pressure to the chamber such that fluid adjacent the orifice is drawn into the chamber;
(d) a positioning system which moves the pulse jet between a dispensing station and a loading station;
(e) a controller which controls the pulse jet, positioning system, pressure source, and striker actuator, which controller:
moves the pulse jet between the loading and dispensing stations;
applies the negative pressure to the chamber when the pulse jet is at the loading station with the orifice adjacent a fluid to be loaded so as to load the fluid into the chamber;
dispenses drops from the pulse jet when at the dispensing station, so as to form the array;
controls the actuator so that the striker strikes the pulse jet at least once between the dispensing of drops by the pulse jet.

26. An array fabrication apparatus according to claim 25 wherein the controller controls the actuator to strike the pulse jet multiple times between the dispensing of drops by the pulse jet.
